(19) United States
(12) Patent Application Publication
(10) Pub. No.: US 2005/0012753 A1
(43) Pub. Date: Jan. 20, 2005

(54) Systems and methods for compositing graphics overlays without altering the primary display image and presenting them to the display on-demand

(75) Inventor: Donald David Karlov, North Bend, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/778,724

(22) Filed: Feb. 13, 2004

Related U.S. Application Data
(63) Continuation-in-part of application No. 10/622,597, filed on Jul. 18, 2003.

(51) Int. Cl. G06F 13/00

(52) U.S. Cl. 345/538

(57) ABSTRACT

The present invention is directed to a method for rendering a composite image (comprising a primary object image and at least one graphical overlay) wherein the GPU and VRAM are bypassed altogether and the resulting displayed graphics are instead rendered in RAM by the CPU and copied directly to the frame buffer. This method not only avoids the data flow problems inherent to computer systems that favor system-to-video flow of data traffic (that is, computer systems that utilize an AGP) and avoids the “last-write” problem altogether, but which also takes advantage of modem CPUs having increased computational speeds (that are orders-of-magnitude greater than the speeds of legacy processors) and supports complex graphics functions that are necessarily performed by the CPU (and not the GPU) to achieve significant performance gains.

### CROSS-REFERENCE TO RELATED APPLICATIONS

This application is a continuation-in-part of U.S. patent application Ser. No. 10/622,597 (Atty. Docket No. MSFT-1794), filed on Jul. 18, 2003, entitled “SYSTEMS AND METHODS FOR EFFICIENTLY UPDATING COMPLEX GRAPHICS IN A COMPUTER SYSTEM BY BY-PASSING THE GRAPHICAL PROCESSING UNIT AND RENDERING GRAPHICS IN MAIN MEMORY,” the entire contents of which are hereby incorporated herein by reference.

This application is related by subject matter to the inventions disclosed in the following commonly assigned applications, the entire contents of which are hereby incorporated herein by reference: U.S. patent application Ser. No. 10/622,749 (Atty. Docket No. MSFT-1786), filed on Jul. 18, 2003, entitled “SYSTEMS AND METHODS FOR UPDATING A FRAME BUFFER BASED ON ARBITRARY GRAPHICS CALLS”; and U.S. patent application Ser. No. 10/623,220 (Atty. Docket No. MSFT-1787), filed on Jul. 18, 2003, entitled “SYSTEMS AND METHODS FOR EFFICIENTLY DISPLAYING GRAPHICS ON A DISPLAY DEVICE REGARDLESS OF PHYSICAL ORIENTATION.”

### TECHNICAL FIELD

The present invention relates generally to the field of computer graphics, and more particularly to utilization of the central processing unit (CPU) and main system random access memory (RAM) in lieu of a graphical processing unit (GPU) and video random access memory (VRAM) to efficiently render computer graphic overlays (e.g., pop-ups, menus, and cursors) with primary output to form a composite image that is presented on-demand to the frame buffer for display on a display device.

### BACKGROUND

Computer graphics primary output (PO), such as graphics output for an application program, is often rendered by the GPU in VRAM. However, a graphic overlays (GO)—for example, pop-ups, menus, and/or cursors—are often rendered by the CPU in RAM instead of by the GPU in VRAM, and then one or more GOs are combined with a PO to form a composite image (CI) for output to the display device (the “CPU Method”). However, to derive a CI from both the PO and the GOs, the frame buffer—or, for some embodiments, its logical equivalent in the VRAM, the VRAM shadow memory (VRAMSM)—must be copied from the graphics card to RAM for processing by the CPU to create a composite image (CI), based on the PO and the GO(s), that is then copied from RAM back to the frame buffer for display. However, because AGP favors a system-to-video flow of data traffic, copying graphics from the frame buffer to system memory is time consuming and resource intensive, and thereby effectively negates any gains from utilizing the GPU on the graphics card.

CIs can also be rendered by the GPU in video working memory (VWM) of VRAM that is separate and distinct from the frame buffer (and VRAMSM), and this method (the “GPU Method”) does not suffer from this AGP-related limitation. However, as widely known and well-understood by those of skill in the art, there are other gains to be had by using the CPU to render “complex graphics” (including GOs) in RAM instead of using the GPU to render graphics in the VRAM. Some of these gains are described in detail in the patent applications cited in the cross-reference section herein above. Therefore, it is generally not desirable to render CIs in VWM with the GPU.

In addition, both the GPU Method and the GPU Method suffer from a “last-write problem.” Specifically, after a CI is formed from a PO and GOs and is written back to the frame buffer for display using either method, there is no mechanism guarantee that the frame buffer will not be further altered—for example, by a subsequent update made to the PO by an application—before the display device is updated based on the CI data written to the frame buffer. This last-write problem can cause a “flicker” effect, erroneous graphics output, or other negative graphical display results.

What is needed in the art is an improved approach to rendering CI graphics on a display device without flickers or errors that can occur with legacy methodologies for combining POs and GOs into CIs and displaying them on a display device. The present invention addresses these shortcomings.

### SUMMARY

One embodiment of the present invention is a method for rendering a CI (comprising a PO and at least one GO) wherein the GPU and VRAMSM are bypassed altogether and the resulting displayed graphics are instead rendered in RAM by the CPU and copied directly to the frame buffer. This method not only avoids the data flow problems inherent to computer systems that favor system-to-video flow of data traffic (that is, computer systems that utilize an AGP) and avoids the “last-write” problem altogether, but which also takes advantage of modem CPUs having increased computational speeds (that are orders-of-magnitude greater than the speeds of legacy processors) and supports complex graphics functions that are necessarily performed by the CPU (and not the GPU) to achieve significant performance gains.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the present invention may be incorporated;

FIG. 2 is a block diagram illustrating a typical computer graphics subsystem;

FIG. 3 is a flowchart illustrating the approach by which a PO and GOs are combined to form a CI;

FIG. 4 is a flowchart illustrating the CPU Method for rendering a CI to the frame buffer;

FIG. 5 is a flowchart illustrating the general method of neutralizing the GPU and VRAM and rendering all display graphics in RAM with the CPU in order to avoid the need for reading from the frame buffer and precluding any last-write problems;

FIG. 6 is a flowchart illustrating a specific method for one embodiment of the present invention for rendering CIs in RAM using the CPU and without having to read a PO (or preexisting CI) from the frame buffer while also avoiding the last-write problem; and

FIG. 7 is the block diagram of FIG. 2 modified to illustrate the active components that remain in said computer graphics subsystem when employing certain embodiments of the present invention described herein.

### DETAILED DESCRIPTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

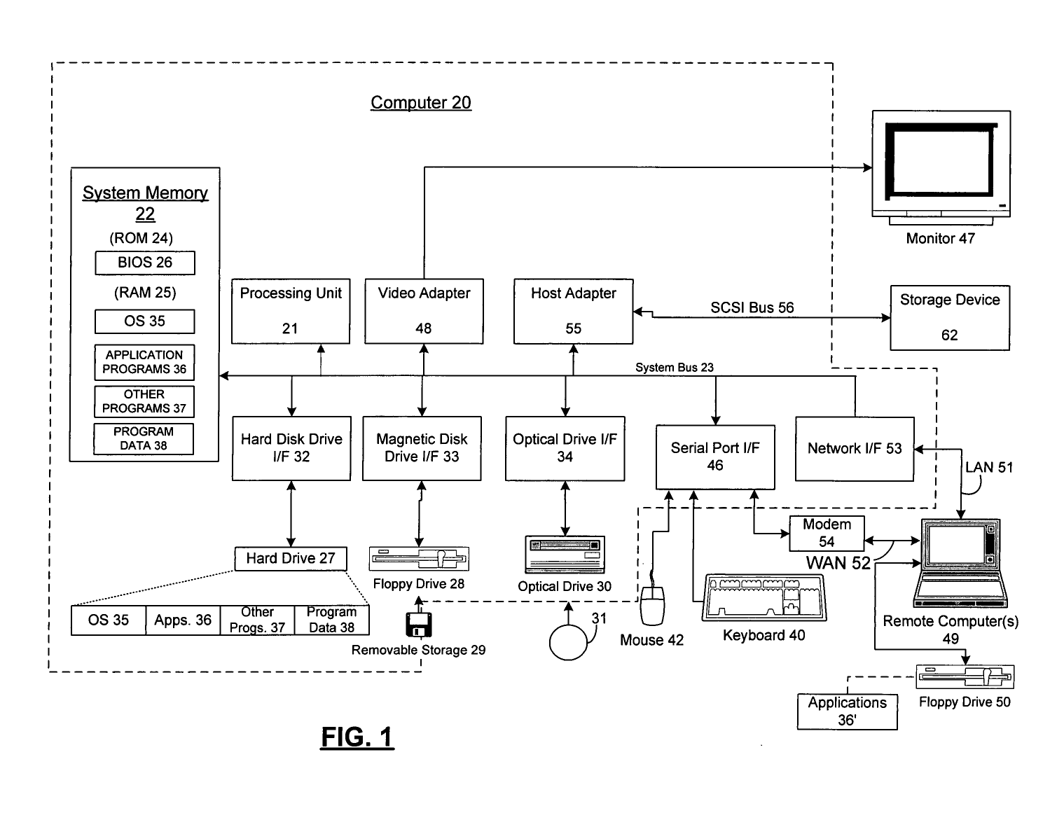

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

While it is envisioned that numerous embodiments of the present invention are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

Graphics Processing Subsystems

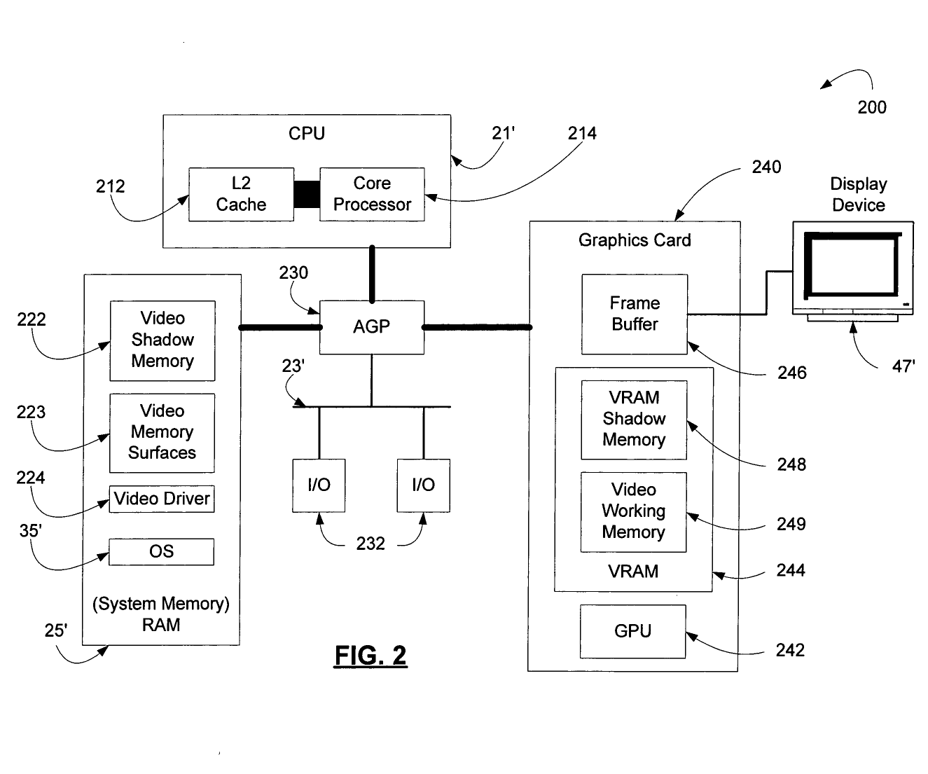

FIG. 2 is a block diagram illustrating a typical computer graphics subsystem 200. The subsystem 200 comprises comprises a CPU 21′ that, in turn, comprises a core processor 214 having an on-chip L1 cache (not shown) and is further directly connected to an L2 cache 212. The L1 cache (not shown) of the CPU '21 is usually built onto the microprocessor chip itself, e.g., the Intel MMX microprocessor comes with a 32 KB L1 cache. The L2 cache 212, on the other hand, is usually on a separate chip (or possibly on an expansion card) but can still be accessed more quickly than RAM, and is usually larger than the L1 cache, e.g., one megabyte is a common size for a L2 cache. As well-known and appreciated by those of skill in the art, the CPU 21′ accessing data and instructions in cache memory is much more efficient than having to access data and instructions in random access memory (RAM 25, referring to FIG. 1), and thus the CPU can achieve significant performance gains that a GPU, which lacks a cache.

The CPU 21′ is connected to an AGP 230. The AGP provides a point-to-point connection between the CPU 21′, the system memory RAM 25′, and graphics card 240, and further connects these three components to other input/output (I/O) devices 232—such as a hard disk drive 32, magnetic disk drive 34, network 53, and/or peripheral devices illustrated in FIG. 1—via a traditional system bus such as a PCI bus 23′. The presence of AGP also denotes that the computer system favors a system-to-video flow of data traffic-that is, that more traffic will flow from the CPU 21′ and its system memory RAM 25′ to the graphics card 240 than vice versa—because AGP is typically designed to up to four times as much data to flow to the graphics card 240 than back from the graphics card 240.

The graphics card 240 further comprises a frame buffer 246 which is directly connected to the display device 47′. As well-known and appreciated by those of skill in the art, the frame buffer is typically dual-ported memory that allows a processor (the GPU 242 or the CPU '21, as the case may be) to write a new (or revised) image to the frame buffer while the display device 47′ is simultaneously reading from the frame buffer to refresh (or “update”) the current display content. The graphics card 240 further comprises a GPU 242 and VRAM 244.

The GPU 242 is essentially a second processing unit in the computer system that has been specifically optimized for graphics operations. Depending on the graphics card, the GPU 242 may be either a graphics coprocessor or a graphics accelerator. When the graphics card is a graphics coprocessor, the video driver 224 sends graphics-related tasks directly to the graphics coprocessor for execution, and the graphics coprocessor alone render graphics for the frame buffer 246 (without direct involvement of the CPU 21′). On the other hand, when a graphics cards is a graphics accelerator, the video driver 224 sends graphics-related tasks to the CPU 21′ and the CPU 21′ then directs the graphics accelerator to perform specific graphics-intensive tasks. For example, the CPU 21′ might direct the graphics accelerator to draw a polygon with defined vertices, and the graphics accelerator would then execute the tasks of writing the pixels of the polygon into video memory (the VRAMSM 248) and, from there, copy the updated graphic to the frame buffer 246 for display on the display device 47′.

Accompanying the GPU 242 is VRAM 244 that enables the GPU to maintain its own shadow memory (the VRAMSM) close at hand for speedy memory calls (instead of using RAM), and may also provide additional memory (e.g, VWM) necessary for the additional processing operations such as the GPU Method. The VRAM 244 further comprises a VRAMSM 248 and VWM 249. The VRAMSM 248 is the location in VRAM 244 where the GPU 242 constructs and revises graphic images (including CIs in the GPU Method), and it is the location from which the GPU 242 copies rendered graphic images to the frame buffer 246 of the graphics card 240 to update the display device 47′. In the GPU Method, the VWM is an additional area of VRAM that is used by the GPU 242 to temporarily store graphics data that might be used by the GPU 242 to store GOs and/or store/restore POs (or portions thereof) among other things. (By offloading this functionality to the graphics card 240, the CPU 21′ and VSM 222 are freed from these tasks.)

The system memory RAM 25′ may comprise the operating system 35′, a video driver 224, video memory surfaces (VMSs) 223, and video shadow memory (VSM) 222. The VSM is the location in RAM 25′ where the CPU 21′ constructs and revises graphic images (including CIs in the CPU Method) and from where the CPU 21′ copies rendered graphic images to the frame buffer 246 of the graphics card 240 via the AGP 230. In the CPU Method, the VMSs are additional areas of RAM that are used by the CPU 21′ to temporarily store graphics data that might be used by the CPU 21′ to store GOs and/or store/restore POs (or portions thereof) among other things.

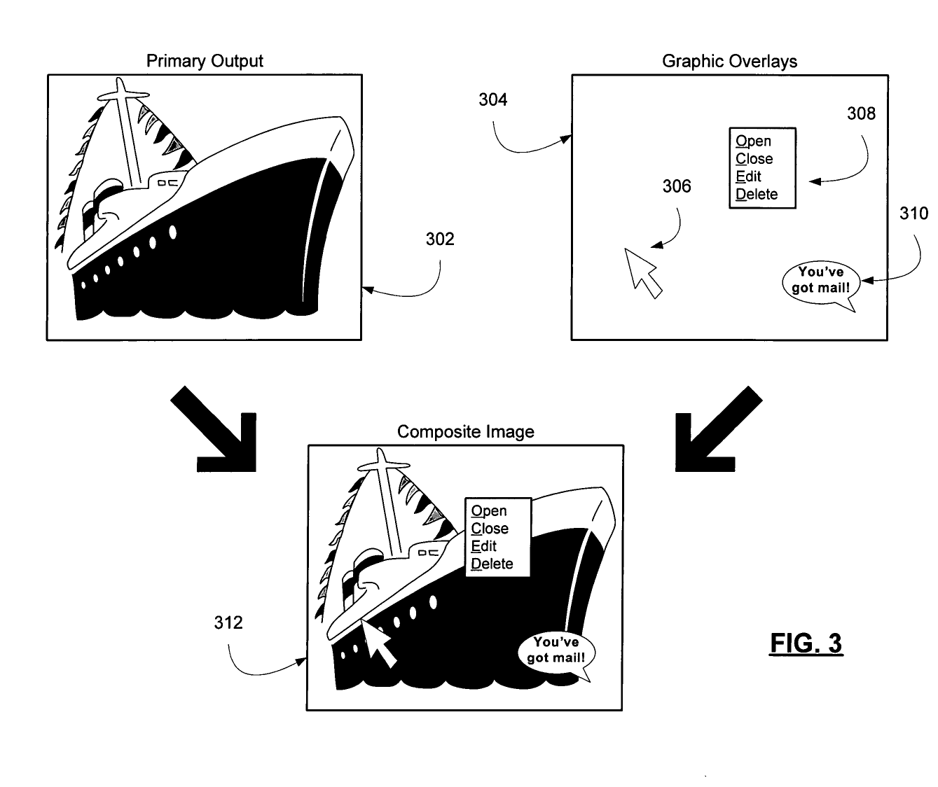

As illustrated in FIG. 3, the subsystem 200 of FIG. 2 ostensibly has the ability to utilize either a CPU Method or a GPU Method to merge a PO 302 and GOs 304 (shown as a single GO composite comprising individual GO components—namely a pointer 306, a menu 308, and a pop-up 310) into a CI 312 for display.

The Direct Render Method

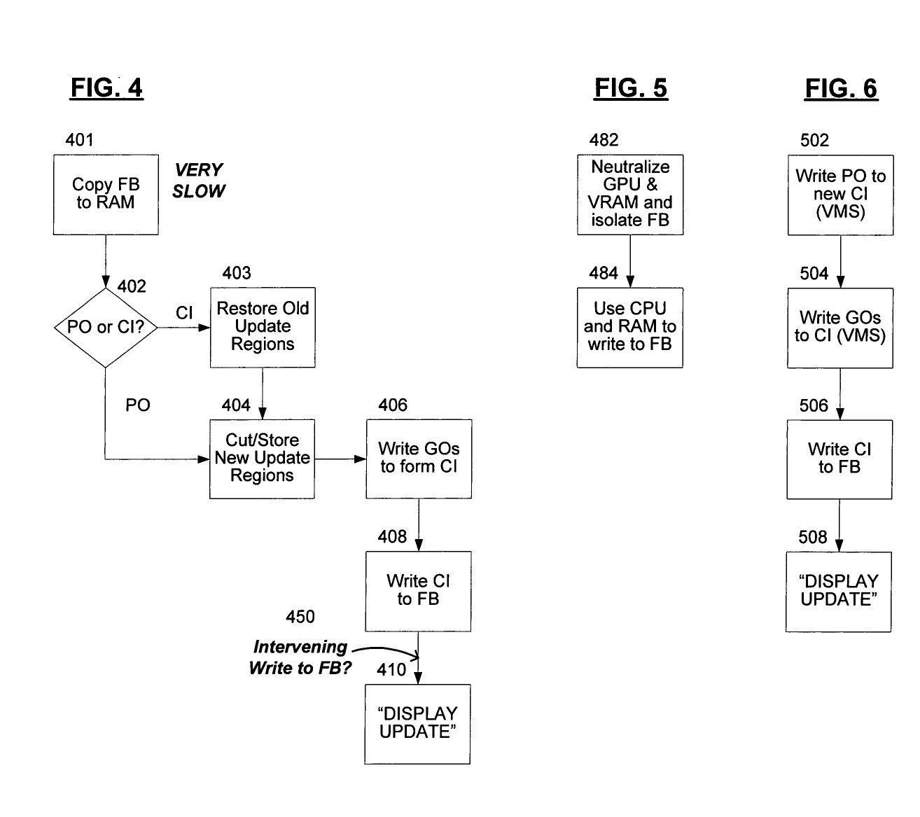

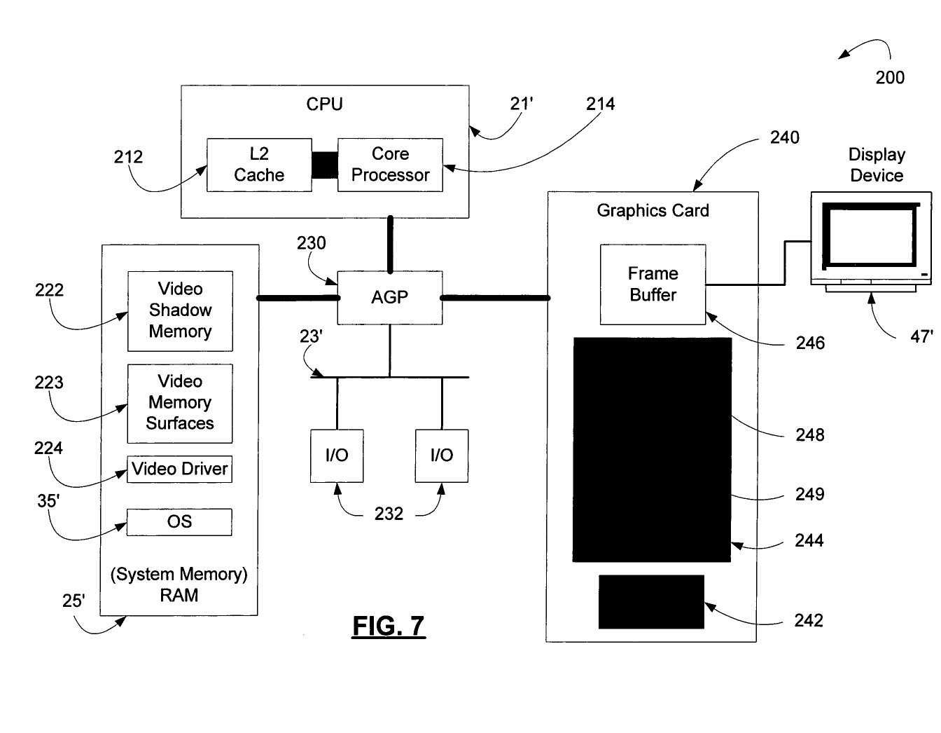

FIG. 4 is a flowchart illustrating an illustrative implementation of the CPU Method for rendering a CI from a clean PO in the frame buffer. Beginning at step 401, the CPU 21′, when called upon to render a CI 312, first copies, via the AGP 230, the contents of the frame buffer 246 (the “Current Display”) to RAM 25′ and, more specifically, to the VSM 222—a very slow process because of the limitations of the AGP 230 (as previously discussed). At step 402, the CPU 21′ then ascertains whether the Current Display is a PO 302 or a previously-rendered CI 312. This might be accomplished by simply checking a single-bit flag that is set whenever the frame buffer is loaded with a CI. If the Current Display is a CI 312, then at step 403 the CPU restores the old update regions to the image stored in the VSM 222 to recreate the PO 302. In this implementation, we presume that the updated regions were cut and stored in the VMS 223 during a previous step just for this purpose; in another implementation, the entire PO 302 might have been stored in the VMS 223, in which case it could simply be recopied in its entirety to the VSM 222. After step 403, or if the CPU 21′ determined that the Current Display was in fact the PO 302 in step 402, at step 404 the CPU 21′, for the present implementation, cuts and stores the regions of the PO 302 that will be updated with GOs 304 and stores this data in the VMS 223 for later retrieval to restore the PO 302 at a later time in the VSM 222 if necessary (as discussed for step 403); in another implementation, the entire PO 302 might instead be stored in the VMS 223 so that it recopied in its entirety back to the VSM 222 at a later time. At step 406, the CPU 21′ would then update the VMS 222 to create the CI 312 by copying the appropriate GOs 304 that are presumably separately stored in the VMS 223 to the remaining portions of the PO 302 in the VSM 222. At step 408, the CI 312 is then written to the frame buffer 246 to update the display device 47′ at the next display update 410. However, in this approach, there is a risk that an intervening write of an updated PO to the frame buffer will occur 450, in which case the display will be incorrect for the period of time it takes the system to call for and an updated CI 312 by returning to step 401 and repeating the process. For frequently changing POs, this can result in a the aforementioned and undesired flicker effect or other display errors.

The method illustrated in FIG. 4 is also largely representative of the GPU Method implementation as well, except the GPU Method would lack the slowness of the copy operation from the frame buffer 246 to VRAMSM 248 in step 401 since the AGP 230 would not be utilized. However, this method is still susceptible to the flicker effect in addition to being a less-than-optimal implementation for other graphics processes that are much more readily handled by the CPU 21′.

To address these shortcomings, the present invention employs a two-part general method comprising the steps illustrated in the flowchart of FIG. 5. Specifically, the method comprises the step 482 of “neutralizing” the GPU 242 and VRAM 248 and “isolating” the frame buffer 246, and the step 484 of using the CPU 21′ and the RAM 25′ to alone “manage” all graphics display operations including the rendering of CIs 312 and writing to the frame buffer 246.

In regard to the first step, the element of “neutralizing” is any state in which the GPU 242 and the VRAM 248 are no longer receiving and/or writing display data to the frame buffer 246, and the step of “isolating” the frame buffer is to prevent anything but the CPU, as the “manager,” to write data to the frame buffer. This step can be accomplished by a number of means; for example, the operating system 35′ might simply prevent any applications, drivers, etc. from communicating directly to the GPU, writing data to VRAM, redirecting all graphics calls to the CPU and its “manage” process, and also preventing applications from circumventing the CPU's “manage” processes for writing data to the frame buffer.

In regard to the second step, the element of using the CPU 21′ and the RAM 25′ to alone “manage” the process, this step essentially equates to having the CPU, utilizing a single process or a coordinated series of processes (the “manager”), to uniformly manage all graphics display data for storing POs and GOs in RAM, rendering CIs in RAM, writing POs and CIs to the frame buffer as appropriate and only as needed (which is the on-demand feature), and resolving conflicting requests for the graphics-based services the CPU provides.

One embodiment of the present invention to address the aforementioned shortcomings using this general methodology is illustrated in FIG. 5. In this embodiment, at step 502, the CPU (and the CPU alone), when called upon to render a CI 312, would write the PO 302, presumably stored in the VMS 223, directly to the VSM 222 and then, at step 504, copy any GOs, also presumably stored in the VMS 223, on top of the PO 302 in the VSM 222 to form the CI 312. This CI 312, once completely rendered, would then be written to the frame buffer 246 in a single, on-demand copy operation at step 506, and the display device will be updated with the CI 312 when it updates at step 508. By utilizing the CPU 21′ to alone render all graphics displays, the CPU 21′ manages all updates to both the PO 302 and the GOs 304 but storing each such component part in the VMS 223 when the arise, then combining the elements in the VSM 222 and, in a single on-demand write operation, providing a single update to the frame buffer 246. Moreover, additional efficiencies can be obtained by using the CPU 21′ to render all video graphics as taught by the other applications identified in the cross-reference section herein above.

FIG. 7 is the block diagram of FIG. 2 modified to illustrate the active components that remain in said computer graphics subsystem when employing certain embodiments of the present invention described herein.

### CONCLUSION

The various system, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

1. A method for rendering a composite image for display on a display device for a computer system having a central processing unit, system random access memory, and a graphics card, said graphics card comprising a graphical processing unit, video random access memory, and a frame buffer, said method comprising:
rendering, in said system random access memory using said central processing unit, said composite image from a current display—said current display being a logical equivalent to a current image in said frame buffer and displayed on a display device coupled to said frame buffer, and said current display stored in system random access memory—and a graphic overlay stored in said system random access memory; and
copying said composite image from said system random access memory to said frame buffer for display on said display device.

2. The method of claim 1 further comprising the step of neutralizing said graphical processing unit to prevent said graphical processing unit from writing data to said frame buffer.

3. The method of claim 2 wherein said step of neutralizing said graphical processing unit is to prevent a graphics call being made to said graphical processing unit.

4. The method of claim 2 wherein said step of neutralizing said graphical processing unit is performed by an operating system residing on said computer system.

5. The method of claim 2 further comprising the step of neutralizing said video random access memory to prevent one or more elements of graphic data from being written to said video random access memory.

6. The method of claim 1 further comprising the step of isolating said frame buffer such that said frame buffer only receives graphics data from the central processing unit.

7. The method of claim 1 wherein the step of rendering comprises the steps of:
copying a primary object image to a video shadow memory, said video shadow memory being a subpart of said system random access memory; and
copying at least one graphical overlay to an update region in said video shadow memory to render said composite image;
and wherein said composite image is copied from said video shadow memory to said frame buffer.

8. A system for rendering a composite image for display on a display device, said system comprising
a central processing unit,
a system random access memory,
a graphics card, said graphics card comprising a graphical processing unit, video random access memory, and a frame buffer,
a display device,
a process running on said central processing unit, for:
rendering, in said system random access memory, said composite image from a current display—said current display being a logical equivalent to a current image in said frame buffer and displayed on a display device coupled to said frame buffer, and said current display stored in system random access memory—and a graphic overlay stored in said system random access memory; and
copying said composite image from said system random access memory to said frame buffer for display on said display device.

9. The system of claim 8 further comprising a subsystem for neutralizing said graphical processing unit from writing data to said frame buffer.

10. The system of claim 9 further comprising a subsystem for neutralizing said graphical processing unit by preventing a graphics call being made to said graphical processing unit.

11. The system of claim 9 further comprising an operating system that neutralizes said graphical processing unit by preventing graphics calls from being made to said graphical processing unit.

12. The system of claim 9 further comprising a subsystem that neutralizes said video random access memory by preventing graphics data from being written to said video random access memory.

13. The system of claim 8 further comprising a subsystem for isolating said frame buffer such that said frame buffer only receives graphics data from the central processing unit.

14. The system of claim 8 further comprising:
a subsystem for copying a primary object image to a video shadow memory, said video shadow memory being a subpart of said system random access memory; and
a subsystem for copying at least one graphical overlay to an update region in said video shadow memory to render said composite image;
a subsystem for copying said composite image in said video shadow memory to said frame buffer.

15. A computer-readable medium comprising computer-readable instructions for rendering a composite image for display on a display device for a computer system having a central processing unit, system random access memory, and a graphics card, said graphics card comprising a graphical processing unit, video random access memory, and a frame buffer, said computer-readable instructions comprising:
instructions for rendering, in said system random access memory using said central processing unit, said composite image from a current display-said current display being a logical equivalent to a current image in said frame buffer and displayed on a display device coupled to said frame buffer, and said current display stored in system random access memory- and a graphic overlay stored in said system random access memory; and
instructions for copying said composite image from said system random access memory to said frame buffer for display on said display device.

16. The computer-readable instructions of claim 15 further comprising instructions for neutralizing said graphical processing unit to prevent said graphical processing unit from writing data to said frame buffer.

17. The computer-readable instructions of claim 16 further comprising instructions for neutralizing said graphical processing unit to prevent a graphics call being made to said graphical processing unit.

18. The computer-readable instructions of claim 16 further comprising instructions for an operating system to neutralize said graphical processing unit.

19. The computer-readable instructions of claim 16 further comprising instructions for neutralizing said video random access memory to prevent one or more elements of graphic data from being written to said video random access memory.

20. The computer-readable instructions of claim 15 further comprising instructions for isolating said frame buffer such that said frame buffer only receives graphics data from the central processing unit.

21. The computer-readable instructions of claim 15 further comprising instructions for:
copying a primary object image to a video shadow memory, said video shadow memory being a subpart of said system random access memory;
copying at least one graphical overlay to an update region in said video shadow memory to render said composite image; and
copying said composite image from said video shadow memory to said frame buffer.

22. A hardware control device for rendering a composite image for display on a display device for a computer system having a central processing unit, system random access memory, and a graphics card, said graphics card comprising a graphical processing unit, video random access memory, and a frame buffer, said hardware control device comprising means for:
rendering, in said system random access memory using said central processing unit, said composite image from a current display—said current display being a logical equivalent to a current image in said frame buffer and displayed on a display device coupled to said frame buffer, and said current display stored in system random access memory—and a graphic overlay stored in said system random access memory; and
copying said composite image from said system random access memory to said frame buffer for display on said display device.

23. The hardware control device of claim 22 further comprising means for neutralizing said graphical processing unit to prevent said graphical processing unit from writing data to said frame buffer.

24. The hardware control device of claim 23 further comprising means for neutralizing said graphical processing unit is to prevent a graphics call being made to said graphical processing unit.

25. The hardware control device of claim 23 further comprising means for an operating system to neutralizing said graphical processing unit.

26. The hardware control device of claim 23 f further comprising means for neutralizing said video random access memory to prevent one or more elements of graphic data from being written to said video random access memory.

27. The hardware control device of claim 22 further comprising means for isolating said frame buffer such that said frame buffer only receives graphics data from the central processing unit.

28. The hardware control device of claim 22 further comprising means for:
copying a primary object image to a video shadow memory, said video shadow memory being a subpart of said system random access memory;
copying at least one graphical overlay to an update region in said video shadow memory to render said composite image; and
copying said composite image from said video shadow memory to said frame buffer.
